(19) United States
(12) Patent Application Publication
(10) Pub. No.: US 2011/0135405 A1
(43) Pub. Date: Jun. 9, 2011

(54) ROLLER APPARATUS AND TRANSPORTATION APPARATUS

(76) Inventors: Akira MIYAJI, Tokyo (JP); Takashi Masukawa, Yokohama-shi (JP)

(21) Appl. No.: 12/958,800

(22) Filed: Dec. 2, 2010

Related U.S. Application Data
(60) Provisional application No. 61/282,031, filed on Dec. 4, 2009.

(51) Int. Cl. B65G 53/34; B65G 53/06; B65G 13/02

(52) U.S. Cl. 406/70; 406/86

(57) ABSTRACT

A roller apparatus includes a roller apparatus that is used to transport a transportation target, the roller apparatus including: a roller body which is adapted to be rotatable; and a flow forming apparatus which forms a flow of a fluid between a surface of the roller body and the transportation target.

### CROSS-REFERENCE TO RELATED APPLICATION

This application is a non-provisional application claiming priority to and the benefit of U.S. provisional application No. 61/282,031, filed on Dec. 4, 2009. The entire contents of which are incorporated herein by reference.

### BACKGROUND

The present invention relates to a roller apparatus and a transportation apparatus.

As a display element forming a display device such as a display, for example, a liquid crystal display element, an organic electroluminescence (organic EL) element, an electrophoretic element used in electronic paper, and the like are known. Currently, as the display element, an active element (active device) is mainly used that has a structure in which a switching element (Thin Film Transistor: TFT) called a thin film transistor is formed on a surface of a substrate and each display device is formed thereon. For example, the organic EL element includes positive and negative poles on the substrate with the TFT formed thereon, and an organic light emission layer interposed between the positive and negative poles. In the organic EL element, a positive hole is injected from the positive pole to the organic light emission layer, the positive hole is combined with an electron in the organic light emission layer, and display light is obtained by emission light generated at the time of the combination. The organic EL element has a structure in which, for example, an electric circuit and the like connected to positive and negative poles are formed on a substrate.

As one of methods of forming the display element such as an organic EL element, for example, a method called a roll-to-roll method (hereinafter, simply referred to as a “roll method”) is known (for example, refer to International Application Publication No. WO 2006/100868). In the roll method, a substrate is transported while one sheet-like substrate (for example, a band-shaped film member) wound on a supply roller on a substrate supply side is supplied and the supplied substrate is wound on a collection roller on a substrate collection side. Then, for the time when the substrate is supplied and wound, a gate electrode forming TFT, a gate oxide film, a semiconductor film, a source/drain electrode, and the like are formed by using plural processing apparatuses, and then a light emission layer forming an organic EL element, a positive pole, a negative pole, an electric circuit, or the like is sequentially formed on a substrate. Further, in the roll method, a transportation roller for transporting the substrate or a direction changing roller for changing the direction of the substrate may be used inside the processing apparatus in addition to, for example, a substrate supply roller or a substrate collection roller.

### SUMMARY

However, for example, when the direction of the substrate is changed by the direction changing roller, the substrate may be stretched in the transportation direction (flow direction, sending direction) by the roller, or a treatment surface (a surface treated by a processing apparatus) of the substrate may come into contact with the surface of the roller, which raises a concern that a treatment surface or an object formed on the treatment surface is influenced.

A purpose of aspects of the present invention is to provide a roller apparatus and a transportation apparatus capable of transporting a transportation target while not contacting the transportation target.

According to a first aspect of the invention, there is provided a roller apparatus that is used to transport a transportation target, the roller apparatus including: a roller body which is adapted to be rotatable; and a flow forming apparatus which forms a flow of a fluid between a surface of the roller body and the transportation target.

According to a second aspect of the invention, there is provided a transportation apparatus including: a roller apparatus which is provided in at least a part of a transportation path of a transportation target, wherein the roller apparatus of the invention is used as the roller apparatus.

According to aspects of the present invention, it is possible to transport a transportation target while not contacting the transportation target.

### BRIEF DESCRIPTION OF THE DRAWINGS

FIG. 1 is a perspective view illustrating a configuration of a roller apparatus.

FIG. 2A is a cross-sectional view illustrating a configuration of the roller apparatus.

FIG. 2B is a cross-sectional view illustrating a configuration of the roller apparatus.

FIG. 3 is a diagram illustrating an operation of the roller apparatus.

FIG. 4 is a diagram illustrating a schematic configuration of a substrate processing apparatus.

FIG. 5 is a diagram illustrating a configuration of a transportation apparatus.

FIG. 6 is a diagram illustrating a configuration of a part (a roller apparatus part) of the transportation apparatus.

FIG. 7 is a diagram illustrating an operation of the transportation apparatus.

FIG. 8 is a diagram illustrating another configuration of the roller apparatus.

FIG. 9 is a diagram illustrating another configuration of the roller apparatus.

### DESCRIPTION OF EMBODIMENTS

### Roller Apparatus

Hereinafter, a first embodiment of a roller apparatus according to the invention will be described with reference to the drawings.

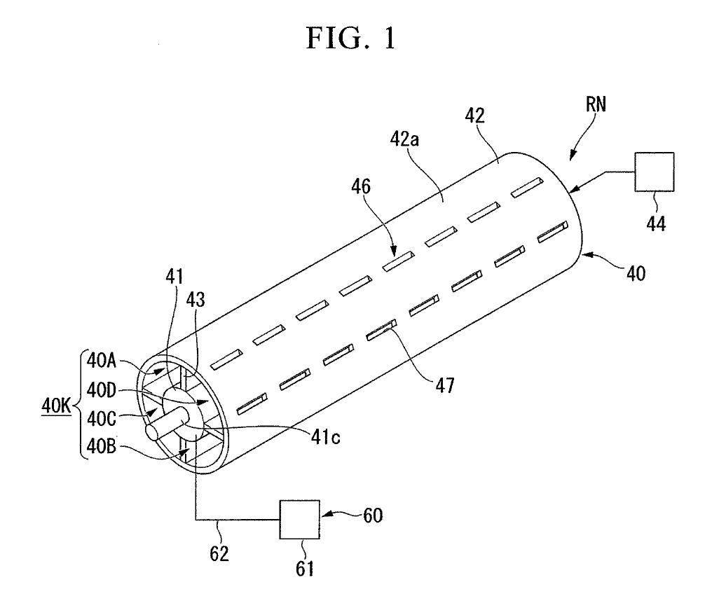

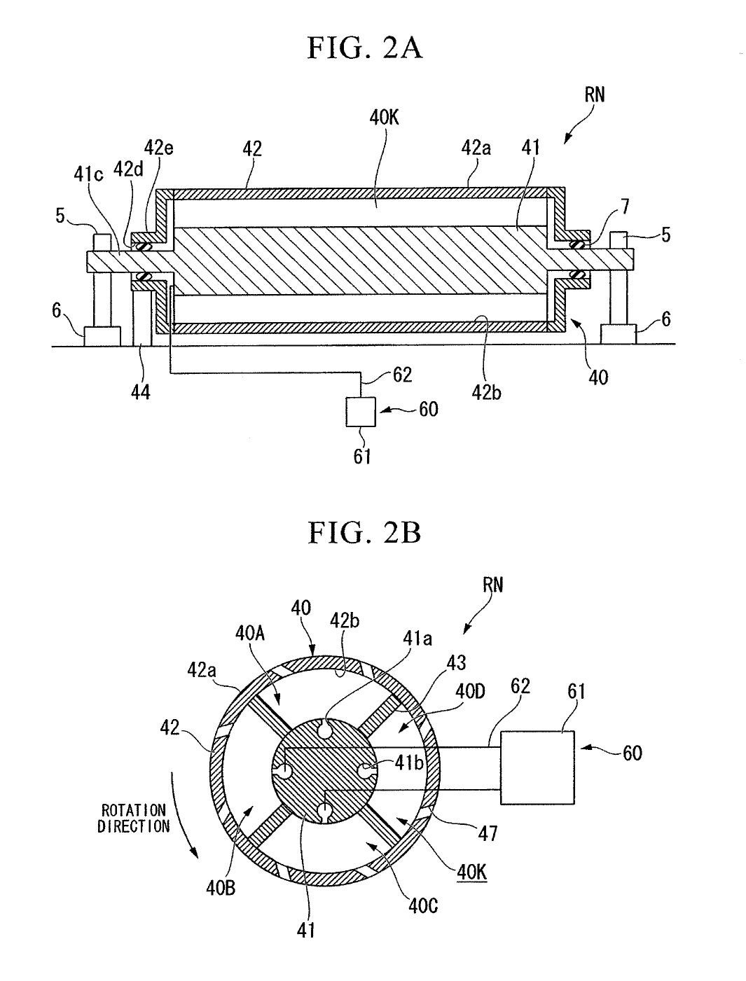

FIG. 1 is a perspective view illustrating a configuration of a roller apparatus RN according to the embodiment. FIGS. 2A and 2B are cross-sectional views illustrating a configuration of the roller apparatus RN shown in FIG. 1. Further, FIG. 2A illustrates a cross-section of a plane parallel to the rotation shaft of the roller apparatus RN. FIG. 2B illustrates a cross-section of a plane perpendicular to the rotation shaft of the roller apparatus RN. Further, in FIG. 1, FIG. 2A and FIG. 2B, some of the components of the roller apparatus RN may be omitted in order to make the drawings easier to understand.

As shown in FIG. 1 and FIGS. 2A and 2B, the roller apparatus RN includes a roller body 40 and a gas flow forming apparatus 60. Further, in the embodiment, a case will be exemplified in which a gas is used as a fluid.

The roller body 40 includes a shaft member 41 and a rotation member 42. The roller body 40 has a configuration in which the rotation member 42 is formed as, for example, a cylindrical shape, and the column-shaped shaft member 41 is received inside the rotation member 42.

For example, as shown in FIG. 2A, a fixation portion 41c is fixed to both end portions of the shaft member 41 of the roller body 40. The fixation portion 41c is supported by a fixation base 6 or the like via, for example, a bearing portion 5 or the like. Further, a cover portion 42e with an opening portion 42d, into which the fixation portion 41c is inserted, is attached to both end surfaces of the rotation member 42 of the roller body 40. The cover portion 42e is attachably and detachably fixed to the rotation member 42. A bearing portion 7 is disposed between the inner peripheral surface of the opening portion 42d and the outer peripheral surface of the fixation portion 41c, and the rotation member 42 is rotatably attached to the fixation portion 41c.

A driving mechanism 44 is connected to the outer peripheral surface of the rotation member 42. The driving mechanism 44 includes a motor (not shown) and a rotation roller which is attached to the rotation shaft of the motor and engages with the outer peripheral surface of the rotation member 42. For example, the rotation roller engages with the outer peripheral surface of the rotation member 42 via a friction force. Further, the rotation member 42 and the rotation roller may engage with each other via a gear. In the driving mechanism 44, when the motor is driven, the rotation roller rotates, the rotation of the rotation roller is transmitted to the rotation member 42, and the rotation member 42 rotates relative to the shaft member 41.

A space is formed between the shaft member 41 and the rotation member 42. Hereinafter, the space is marked as an internal space 40K of the roller body 40. Plural partition members 43 are attached to the surface of the shaft member 41. The partition members 43 are plate-shaped members that divide the internal space 40K. For example, the partition members 43 are formed so as to come into contact with the inner peripheral surface 42b of the rotation member 42 of the shaft member 41.

Further, a low friction material (for example, polytetrafluoroethyleneteflon and the like) is coated on at least one of the inner peripheral surface 42b of the rotation member 42 and the end surface (the surface facing the inner peripheral surface 42b) of the partition member 43. By using a low friction material, the inner peripheral surface 42b of the rotation member 42 may slide on the end surfaces of the partition members 43.

In the embodiment, for example, four partition members 43 are provided at the same pitch in the circumferential direction of the shaft member 41. Further, the arrangement of the partition members 43 may not be performed with the same pitch, but may be performed with different pitches. Further, both end portions of the partition member 43 are blocked by, for example, a cover portion (not shown) or the like. Accordingly, the internal space 40K is divided into four spaces 40A to 40D by the partition members 43, the inner peripheral surface 42b of the rotation member 42, and the cover portion (not shown). Further, for example, a configuration may be adopted in which the internal space 40K is blocked by using the cover portion 42e attached to the rotation member 42. In this configuration, for example, the cover member 42e may come into contact with the partition members 43. In this case, since both end portions of the partition member 43 in the longitudinal direction come into contact with the cover portion 42e, it is desirable that the low friction material is coated on the contact portion (for example, at least one of the cover portion 42e and the partition member 43).

For example, as shown in FIG. 2B, the surface of the shaft member 41 is provided with a gas discharge port 41a, and a gas channel 41b is formed inside the shaft member 41. The gas discharge port 41a is provided at each of four spaces 40A to 40D. Plural gas discharge ports 41a are respectively provided in the spaces 40A to 40D, for example, in the longitudinal direction of the shaft member 41. Further, as a configuration of the gas discharge port 41a, for example, the gas discharge port may be formed in a slit shape in the longitudinal direction of the shaft member 41. The gas discharge port 41a is connected to the gas channel 41b inside the shaft member 41. The gas channel 41b is formed in the longitudinal direction of the shaft member 41, and is provided until reaching at least one end portion of the shaft member 41 in the longitudinal direction.

The surface (the outer peripheral surface) 42a of the rotation member 42 is provided with a gas discharge portion 46. The gas discharge portion 46 discharges a gas onto the outer peripheral surface 42a. The gas discharge portion 46 includes a gas discharge port 47 that is formed on the rotation member 42. The gas discharge port 47 is a hole that perforates the outer peripheral surface 42a and the inner peripheral surface 42b of the rotation member 42. The hole extends between the outer peripheral surface 42a and the inner peripheral surface 42b of the rotation member 42. The internal space K of the rotation member 42 and the outside of the rotation member 42 communicate with each other via the gas discharge port 47.

Plural gas discharge ports 47 are provided in the rotation member 42. The plural gas discharge ports 47 are arranged, for example, in the longitudinal direction of the rotation member 42. Plural rows of gas discharge ports 47 are provided in the circumferential direction (a rotation direction) of the rotation member 42. In the embodiment, the rows of the gas discharge ports 47 are arranged at positions deviated from each other by the same angle (for example, 45°) in the circumferential direction of the rotation member 42. Of course, the invention is not limited to this configuration. A configuration may be adopted in which the rows of the gas discharge ports 47 are provided in the circumferential direction of the rotation member 42 every angle different from 45°, or a configuration may be adopted in which the rows of the gas discharge ports 47 are provided at different pitches. Each of the gas discharge ports 47 is formed as, for example, a slit shape, and is formed to be inclined in the rotation direction of the rotation member 42.

The gas flow forming apparatus 60 includes a gas supply mechanism 61 and a tube member 62.

The gas supply mechanism 61 is a supply source for a gas, for example, an inert gas such as nitrogen gas or argon gas or compressed air. As the gas supply mechanism 61, for example, a gas bottle or the like may be used. Further, for example, when compressed air or nitrogen gas is supplied, a supply line for compressed air or nitrogen gas installed in a factory or the like may be used as the gas supply mechanism 61.

The tube member 62 is a tubular member that connects the gas supply mechanism 61 and the shaft member 41 to each other. As shown in FIG. 2B, the tube member 62 is connected to the gas channel 41b, for example, at the end portion of the shaft member 41. FIG. 2B illustrates an exemplary configuration in which the tube member 62 is connected to the gas channels 41b connected to the spaces 40B and 40C among four spaces 40A to 40D. Of course, the invention is not limited to this configuration. For example, a configuration may be adopted in which the tube member is connected to four gas channels 41b. Further, a configuration may be adopted in which the tube member is connected to three gas channels 41b or one gas channel 41b. In this case, the gas channel 41b connected to the tube member 62 may be switched. The tube member 62 is provided with a valve mechanism (not shown) such as an electromagnetic valve or a butterfly valve. Further, the gas channel 41b may be connected to the tube member 62 via, for example, the inside of the fixation portion 41c or the like.

The gas flow forming apparatus 60 supplies a gas from the gas supply mechanism 61 to the outer peripheral surface 42a of the rotation member 42 via the tube member 62, the gas channel 41b, the gas discharge port 41a, the internal space 40K, and the gas discharge port 47 (the gas discharge port 46). In this way, from the functional viewpoint that a gas is supplied to the outer peripheral surface 42a of the rotation member 42, the gas flow forming apparatus 60 may include the gas supply mechanism 61 as a gas supply path, the tube member 62, the gas channel 41b, the gas discharge port 41a, the internal space 40K, and the gas discharge port 47 (the gas discharge portion 46).

Next, an operation of the roller apparatus RN will be described. Here, for example, a case will be exemplified in which a sheet substrate (a film member) ST having flexibility is transported as a transportation target.

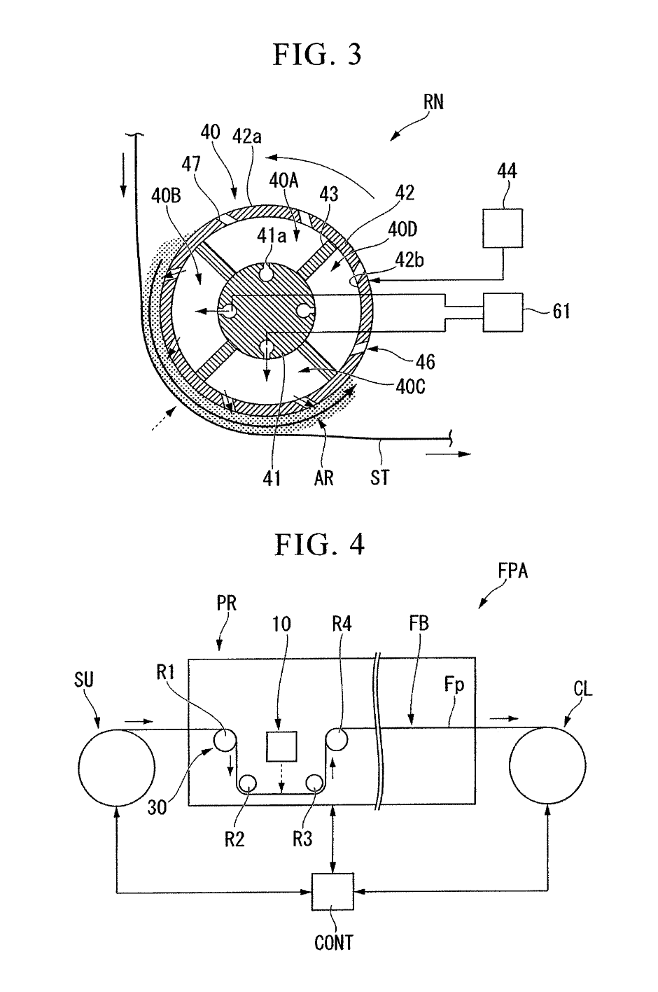

First, as shown in FIG. 3, the shaft member 41 is fixed, and the sheet substrate ST moves close to the rotation member 42 in a non-contact state by bending the sheet substrate ST so as to follow the outer peripheral surface 42a of the portion corresponding to the spaces 40B and 40C of the rotation member 42.

In this state, for example, the driving mechanism 44 rotates the rotation member 42 in the counter-clockwise direction in the drawing. In accordance with the operation, the rotation member 42 rotates about the shaft member 41 while coming into contact with the front end of the partition member 43. Since the shaft member 41 is fixed, the position of the partition member 43 does not change, and the rotation member 42 rotates independently from the partition members 43. Further, in accordance with the rotation of the rotation member 42, the position of the gas discharge port 47 moves in the counter-clockwise direction of the drawing, and the connection position of the gas discharge port 47 is sequentially and repeatedly switched to the spaces 40A, 40B, 40C, and 40D.

Further, the gas flow forming apparatus 60 supplies a gas from the gas supply mechanism 61 to the gas channel 41b via the tube member 62. In accordance with the operation, a gas is supplied from the gas channel 41b to the spaces 40B and 40C. In accordance with the rotation of the rotation member 42, the gas supplied to the spaces 40B and 40C is discharged from the gas discharge port 47 while the gas discharge port 47 is connected to the spaces 40B and 40C.

Since the gas discharge port 47 faces the rotation direction of the rotation member 42, the gas discharged from the gas discharge port 47 flows in the rotation direction of the rotation member 42. The gas flows between the rotation member 42 and the sheet substrate ST. For this reason, in the portion corresponding to the spaces 40B and 40C of the outer peripheral surface 42a, a gas flow is formed between the sheet substrate ST and the rotation member 42. In the portion forming the gas flow (the gas flow forming portion AR), a dynamic pressure is generated by the formation of the gas flow, and a static pressure rapidly decreases by an amount of the dynamic pressure (Bernoulli's theorem). As a result, since the static pressure of the gas flow forming portion AR becomes lower than the static pressure of the peripheral space, the sheet substrate ST is pulled toward the rotation member 42 due to a difference in the static pressure.

Since the gas flow formed between the rotation member 42 and the sheet substrate ST is also a layer of a gas, the pulled sheet substrate ST is held with the gas layer interposed between the rotation member 42 and the sheet substrate. For this reason, the sheet substrate ST does not come into contact with the rotation member 42. The sheet substrate ST is transported in the rotation direction of the rotation member 42 by viscous drag while not contacting the rotation member 42 in accordance with the rotation of the rotation member 42. In this way, in the roller apparatus RN, the sheet substrate ST is transported while changing the transportation direction.

As described above, according to the embodiment, since the roller apparatus RN used to transport the transportation target (the sheet substrate ST) includes the roller body 40 adapted to be rotatable and the gas flow forming apparatus 60 forming a gas flow between the surface (the outer peripheral surface 42a) of the roller body 40 and the sheet substrate ST, it is possible to transport the sheet substrate ST while not being in a contacting state.

Further, according to the embodiment, since the sheet substrate ST can be transported while not being in a contacting state, the roller apparatus RN does not generate a needless tensile force for pulling the sheet substrate ST. For this reason, it is possible to change the transportation direction without causing deformation such as stretching of the sheet substrate ST.

[Transportation Apparatus]

Next, an embodiment of the transportation apparatus according to the invention will be described. FIG. 4 is a diagram illustrating a configuration of a substrate processing apparatus FPA having the transportation apparatus according to the invention. The substrate processing apparatus FPA shown in FIG. 4 is provided with the transportation apparatus 30 having the roller apparatus RN described in the above-described embodiment. Hereinafter, a configuration of the substrate processing apparatus FPA will be described.

As shown in FIG. 4, the substrate processing apparatus FPA includes a substrate supply unit SU which supplies the sheet substrate (for example, a film member) FB, a substrate processing unit PR which performs a treatment on the sheet substrate FB, a substrate collection unit CL which collects the sheet substrate FB, and a control unit CONT which controls the respective units. The substrate processing apparatus FPA is used in, for example, a factory and the like.

The substrate processing apparatus FPA is a device which performs a treatment on the band-shaped sheet substrate FB using a roll. The substrate processing apparatus FPA may be used, for example, when forming an element such as an organic EL element and a circuit element on the sheet substrate FB. Of course, the substrate processing apparatus FPA may be used when forming elements other than the mentioned elements.

As the sheet substrate FB as a treatment target in the substrate processing apparatus FPA, for example, a foil such as a stainless steel or a resinous film may be used. For example, materials of the resinous film may include a polyethylene resin, a polypropylene resin, a polyester resin, an ethylene vinyl copolymer resin, a polyvinyl chloride resin, a cellulose resin, a polyamide resin, a polyimide resin, a polycarbonate resin, a polystyrene resin, a vinyl acetate resin, and the like.

The dimension of the sheet substrate FB in the Y direction (the width direction) is, for example, about 1 m to 2 m, and the dimension in the X direction (the longitudinal direction) is, for example, 10 m or more. Of course, these dimensions are mere examples, but the invention is not limited thereto. For example, the dimension of the sheet substrate FB in the Y direction may be 50 cm or less, or 2 m or more. In addition, the dimension of the sheet substrate FB in the X direction may be 10 m or less.

The sheet substrate FB is formed to have, for example, flexibility. Here, flexibility means that the substrate is bendable without breaking the substrate breaking even when, for example, at least a predetermined force approximately equal to the weight of the substrate is applied thereto. Further, for example, the property of being able to be bent by the predetermined force is included in the consideration of flexibility. Further, the flexibility changes in accordance with an environment such as the temperature, the thickness, the size, or the material of the corresponding substrate. In addition, one band-shaped substrate may be used as the sheet substrate FB, and plural unit substrates may be used in a band shape while being connected to each other.

It is desirable that the thermal expansion coefficient of the sheet substrate FB is small so that the dimension thereof does not change even when, for example, a heat of about 200° C. is applied thereto. For example, the thermal expansion coefficient may be made small by mixing inorganic filler with a resinous film. Examples of the inorganic filler include titanium oxide, zinc oxide, alumina, silicon oxide, and the like.

The substrate supply unit SU supplies the sheet substrate FB wound, for example, in a roll shape to the substrate processing unit PR by reeling out the substrate. The substrate supply unit SU includes, for example, a shaft portion on which the sheet substrate FB is wound or a rotational driving source which rotates the shaft portion. In addition, the substrate supply unit may include, for example, a cover portion which covers the sheet substrate FB wound in a roll shape.

The substrate collection unit CL collects the sheet substrate FB from the substrate processing unit PR by winding the substrate, for example, in a roll shape. As in the substrate supply unit SU, the substrate collection unit CL includes a shaft portion on which the sheet substrate FB is wound, a rotational driving source which rotates the shaft portion, or a cover portion which covers the collected sheet substrate FB. In addition, when the sheet substrate FB is cut, for example, in a panel shape in the substrate processing unit PR, the sheet substrates FB may be collected in an overlapping manner, which is different from the method of collecting the sheet plate in a roll shape.

The substrate processing unit PR transports the sheet substrate FB supplied from the substrate supply unit SU to the substrate collection unit CL, and performs a treatment on a treatment surface Fp of the sheet substrate FB during the transportation. The substrate processing unit PR includes a processing apparatus 10 and the transportation apparatus 30. In addition, the substrate processing unit PR may include an alignment mechanism performing an alignment operation or the like on the sheet substrate FB.

The processing apparatus 10 includes various devices which form, for example, an organic EL element on the treatment surface Fp of the sheet substrate FB. Examples of the processing apparatus include a partition forming device which forms a partition on the treatment surface Fp, an electrode forming device which forms an electrode for driving an organic EL element, and a light emission layer forming device which forms a light emission layer. More specifically, a liquid droplet application device (for example, an ink jet application device, a spin coating application device, and the like), a film forming device such as a deposition device or a sputtering device, an exposure device, a development device, a surface quality improving device, a cleaning device, and the like may be exemplified. For example, the devices are appropriately provided on the transportation path of the sheet substrate FB.

The transportation apparatus 30 includes, for example, a roller apparatus R which transports the sheet substrate FB to the substrate collection unit CL inside the substrate processing unit PR. For example, plural roller apparatuses R are provided along the transportation path of the sheet substrate FB. A driving mechanism (not shown) is attached to the roller apparatus R in at least a part of the plural roller apparatuses R. When the roller apparatuses R rotate, the sheet substrate FB is transported in the X direction. For example, a part of the roller apparatuses R among the plural roller apparatuses R may be adapted to be movable in a direction perpendicular to the transportation direction.

The plural roller apparatuses R include, for example, contact type roller apparatuses RC (R1 and R4) which come into contact with the sheet substrate FB and non-contact type roller apparatuses RN (R2 and R3) which do not come into contact with the sheet substrate FB. The roller apparatus RN is used as the non-contact type roller apparatus RN. Further, instead of the contact type roller RC, the non-contact type roller RN may be used.

For example, the non-contact type roller apparatus R2 and the roller apparatus R3 are disposed on the side of the treatment surface Fp of the sheet substrate FB. For this reason, the sheet substrate FB is transported without contacting the treatment surface Fp, thereby preventing, for example, an accident in which the treatment surface Fp is damaged by the roller apparatuses R2 and R3 or an object formed on the treatment surface Fp is damaged.

In addition, since the roller apparatus R2 and the roller apparatus R3 do not contact the sheet substrate FB, the sheet substrate FB is transported without applying a needless tensile force to the sheet substrate FB. For this reason, for example, when the sheet substrate FB is transported via the roller apparatus R2 and the roller apparatus R3, the transportation direction of the sheet substrate FB can be changed without causing deformation such as stretching of the sheet substrate FB in the longitudinal direction.

For example, the roller apparatus R2 and the roller apparatus R3 are respectively disposed on the upflow side and the downflow side of the processing apparatus 10 in the transportation direction. With this configuration, since a needless tensile force is not applied to the portion treated by the processing apparatus 10 in the sheet substrate FB, it is possible to prevent the occurrence of treatment errors.

In the roller apparatus R2, as shown in FIGS. 2A and 2B of the above-described embodiment, for example, the connection position of the tube member 62 of the gas flow forming apparatus 60 may be set to, for example, the gas channel 41b connected to the space 40B and the gas channel 41b connected to the space 40C among four spaces 40A to 40D of the roller body 40. Further, in the roller apparatus R3, differently from the configuration shown in FIGS. 2A and 2B, for example, the connection position of the tube member 62 may be set to the gas channel 41b connected to the space 40D and the gas channel 41b connected to the space 40C. With this configuration, a gas flow is generated at the portion where the sheet substrate FB and the outer peripheral surfaces 42a of the roller apparatuses R2 and R3 face each other.

As described above, according to the embodiment, the roller apparatus R is provided in at least a part of the transportation path of the sheet substrate FB, and the roller apparatus RN is used as the roller apparatus R. Accordingly, it is possible to transport the sheet substrate FB in a non-contact state, and to transport the sheet substrate FB without applying an extra tensile force to the sheet substrate FB upon changing the transportation direction.

Next, another embodiment of the transportation apparatus according to the invention will be described. In the embodiment, another type of transportation apparatus transporting the sheet substrate FB will be described.

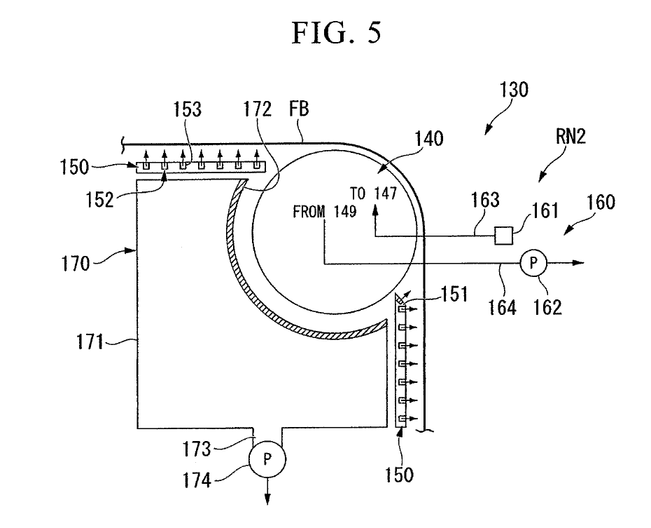

FIG. 5 is a diagram illustrating a configuration of a transportation apparatus 130 according to the embodiment.

As shown in FIG. 5, the transportation apparatus 130 includes a roller apparatus RN2 which transports the sheet substrate FB, an air pad device 150 which guides the sheet substrate FB while supplying a gas onto the transportation path of the sheet substrate FB, and a gas discharge apparatus 170 which discharges a gas to the periphery of the roller apparatus RN2.

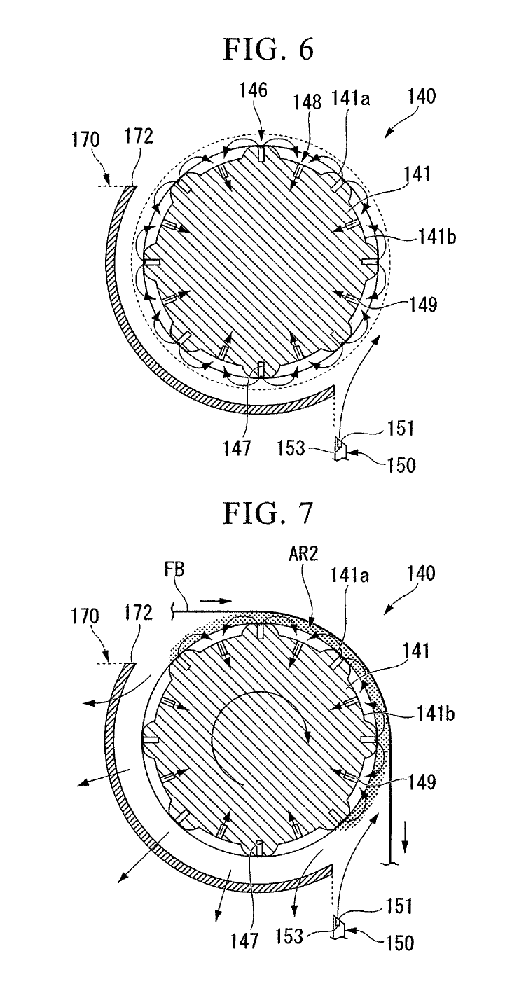

The roller apparatus RN2 includes a roller body 140 which is adapted to be rotatable and a gas flow forming apparatus 160 which forms a gas flow on the surface of the roller body 140. FIG. 6 is a cross-sectional view illustrating a configuration of the roller body 140. As shown in FIG. 6, the roller body 140 includes a rotation member 141, a gas discharge portion 146, and a gas suction portion 148.

The rotation member 141 is formed in a cylindrical shape or a column shape, and is adapted to be rotatable. As the rotation member 141, for example, the rotation member may actively rotate while being connected to a driving mechanism (not shown) or the like, or may be passively rotated by an external force.

The gas discharge portion 146 is provided on the outer peripheral surface 141a of the rotation member 141. The gas discharge portion 146 includes a gas discharge port 147. For example, plural gas discharge ports 147 are formed toward the outside in the radial direction of the rotation member 141. The plural gas discharge ports 147 are formed in series along the longitudinal direction of the rotation member 141, and plural rows of the gas discharge ports 147 are formed in the circumferential direction of the rotation member 141.

The gas suction portion 148 is a portion that sucks the outer peripheral surface 141a of the rotation member 141. The gas suction portion 148 includes a gas suction port 149. The gas suction port 149 is provided inside a concave portion 141b formed in the outer peripheral surface 141a of the rotation member 141. Plural gas suction ports 149 are provided so as to correspond to the gas discharge ports 147. Specifically, each of the gas suction ports 149 is disposed at a position interposed between two gas discharge ports 147 in the circumferential direction of the rotation member 141. In the embodiment, the gas suction port 149 is disposed, for example, at a middle position between two gas discharge ports 147, and the gas discharge port 147 and the gas suction port 149 are alternately arranged at a pitch in the circumferential direction of the rotation member 141. For this reason, a gas is discharged from the gas discharge port 147, and a gas is sucked by the gas suction port 149. Accordingly, the gas from the gas discharge port 147 flows to two gas suction ports 149 adjacent to each other in the circumferential direction of the rotation member 141. Further, the concave portion 141b is formed on the outer peripheral surface 141a so as to correspond to the position of the gas suction port 149.

Returning to FIG. 5, each air pad device 150 is disposed on the upflow side and the downflow side of the roller body 140 when viewed from the transportation direction of the sheet substrate FB. A gas supply portion 152 is provided on the surface on the side of the transportation path of the sheet substrate FB in the air pad device 150. The gas supply portion 152 includes a gas discharge portion 153 which discharges a gas onto the transportation path of the sheet substrate FB at a predetermined emission pressure. In an adjacent portion 151 adjacent to the roller body 140 of the air pad device 150 disposed on the downflow side of the transportation direction of the roller body 140, the gas discharge port 153 faces a gap between the sheet substrate FB and the outer peripheral surface 141a of the roller body 140. In this way, the air pad device 150 is adapted to supply a gas between the sheet substrate FB and the outer peripheral surface 141a.

The gas flow forming apparatus 160 includes a gas supply mechanism 161 and a gas suction mechanism 162. The gas supply mechanism 161 is connected to each gas discharge port 147 of the roller body 140 via, for example, a tube member 163, and supplies a gas discharged from the gas discharge port 147. The gas suction mechanism 162 is connected to each gas suction port 149 of the roller body 140 via, for example, a tube member 164.

The gas discharge apparatus 170 includes a box-shaped member 171, a porous member 172, and an emission port 173. The porous member 172 is formed to face an area excluding an area facing, for example, the sheet substrate FB in the outer peripheral surface 141a of the roller body 140. In the embodiment, the porous member 172 is disposed to face an area interposed between two air pad devices 150 in the outer peripheral surface 141a. The emission port 173 is provided with, for example, an emission mechanism 174 such as a pump. When the emission mechanism 174 is operated, a gas of a space contacting the porous member 172 is received in the box-shaped member 171, and is discharged from the emission port 173.

Next, an operation of the transportation apparatus 130 will be described. FIG. 7 is a diagram illustrating a shape when the transportation apparatus 130 is operated.

As shown in FIG. 7, a gas is discharged from each gas discharge port 147 while rotating the roller body 140 of the transportation apparatus 130, and a gas is sucked by the gas suction port 149, thereby generating a gas flow on the surface of the roller body 140 so as to follow the rotation direction of the roller body 140.

On the other hand, when the gas discharge apparatus 170 is operated, a gas discharge occurs at the space contacting the porous member 172 in the gas flow on the surface of the roller body 140. For this reason, in the outer peripheral surface 141a of the roller body 140, a gas flow along the outer peripheral surface 141a is generated on the area facing the sheet substrate FB (a gas flow forming area AR2), and a gas flow along the outer peripheral surface 141a is not generated on an area contacting the porous member 172.

Even in this case, since a gas flow is generated between the sheet substrate FB and the outer peripheral surface 141a, a static pressure of the gas flow forming area AR2 decreases in accordance with the Bernoulli's theorem, and the sheet substrate FB is pulled toward the roller body 140. When the roller body 140 rotates while the sheet substrate FB is pulled toward the roller body 140, the sheet substrate FB is transported in the rotation direction of the roller body 140.

At this time, the air pad device 150 is operated so that an emission pressure of the gas from the gas discharge port 153 of the air pad device 150 is higher than that of the gas discharge port 147 of the roller body 140. By this operation, it is possible to prevent the sheet substrate FB from being wound around the roller body 140.

Further, the sheet substrate FB is separated from the roller body 140 by the gas flow from the gas discharge port 153 disposed at the adjacent portion 151 in the air pad device 150 disposed on the downflow side in the transportation direction of the roller body 140. For this reason, since it is possible to prevent the sheet substrate FB from being sucked into the roller body 140, it is possible to avoid an accident where the sheet substrate FB comes off from the predetermined transportation path.

As described above, according to the embodiment, the air pad devices 150 are disposed on the upflow side and the downflow side of the roller body 140 in the transportation direction of the sheet substrate FB, and the air pad devices 150 guide the sheet substrate FB while supplying a gas onto the transportation path of the sheet substrate FB. For this reason, it is possible to prevent the sheet substrate FB from being attached to the roller body 140.

Furthermore, according to the embodiment, since the gas suction portion 148 is provided in the roller body 140 in addition to the gas discharge portion 146, it is possible to efficiently form a gas flow on the outer peripheral surface 141a of the roller body 140. Further, since the gas suction port 149 is provided inside the concave portion 141b, it is possible to decrease the thickness of the gas flow formed on the outer peripheral surface 141a. For this reason, it is possible to set the transportation path of the sheet substrate FB to be compact.

The technical scope of the invention is not limited the above-described embodiments, but appropriate modifications may be made within the scope of the concept of the invention.

For example, the configuration of the roller body 40 or 140 is not limited to the above-described embodiments, and a different configuration may be adopted.

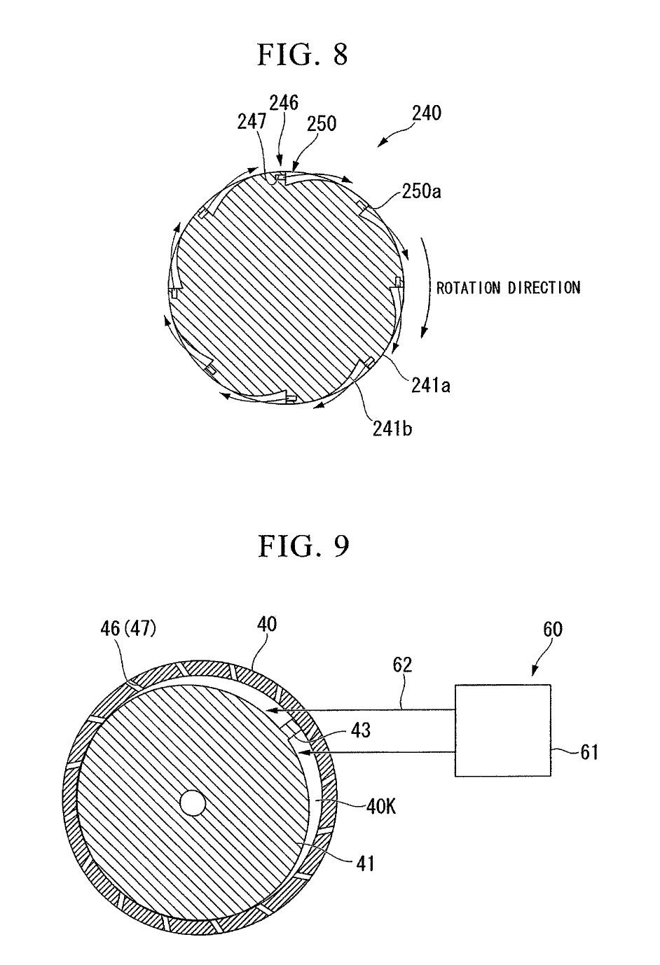

Specifically, for example, as shown in FIG. 8, a step portion 250 may be formed at a portion provided with a gas discharge portion 246 in a roller body 240. As shown in FIG. 8, the step portion 250 has a step surface 250a facing the rotation direction of a rotation member 241 constituting the roller body 240.

The step surface 250a is formed to face the inside in the radial direction from the outer peripheral surface 241a of the rotation member 241. The bottom portion of the step surface 250a is connected to a curved surface 241b gradually returning to the outer peripheral surface 241a in the rotation direction of the rotation member 241. Plural step surfaces 250a are formed on the outer peripheral surface 241a in the circumferential direction.

The gas discharge port 246 includes a gas discharge port 247 in the step surface 250a. For this reason, the gas discharge port 247 is formed to face the rotation direction of the rotation member 241, and a gas is discharged from the gas discharge port 247 in the rotation direction of the rotation member 241. With such a configuration, it is possible to easily form a gas flow along the outer peripheral surface 241a of the roller body 240.

Further, as shown in FIG. 9, for example, one partition member 43 is attached to the shaft member 41, and two spaces 40K are formed between the shaft member 41 and the rotation member 42. In this case, as shown in FIG. 9, the gas supply device x may be connected to each of the two spaces 40K. Further, in the configuration shown in FIG. 9, for example, the partition member 43 comes into contact with the rotation member 42, and a part of the shaft member 41 comes directly into contact with a part of the rotation member 42. In the contact portion between the shaft member 41 and the rotation member 42, for example, the outer surface of the shaft member 41 and the inner surface of the rotation member 42 are uniformly formed without a gap therebetween, and the gas discharge port 47 formed at the portion is blocked by the shaft member 41. For this reason, the gas supplied to the space 40K does not leak from the gas discharge port 47 of the portion coming into contact with the shaft member 41 in the rotation member 42. With this configuration, for example, when a gas is supplied from the gas flow supply device 60, the gas is discharged from the gas discharge port 47 connected to the space 40K by the rotation of the rotation member 42. Accordingly, it is possible to move the sheet substrate ST with a simpler control without changing the supply of the gas during the transportation of the sheet substrate ST as in the first embodiment.

Further, in the above-described embodiments, the shaft member 41 is fixed, and the rotation member 42 is rotated. However, the invention is not limited thereto. For example, when the partition member 43 is provided, the shaft member 41 and the rotation member 42 may be integrated with each other. For example, the rotation member 42 and the shaft member 41 are fixed and rotated together. In accordance with the rotation, a switching timing of an electromagnetic valve or a butterfly valve may be controlled. With this configuration, for example, it is possible to supply a gas from the portion corresponding to the transportation portion of the sheet substrate ST in the rotation member 42 as in the first embodiment.

Further, in the above-described embodiments, a configuration has been exemplified in which the sheet substrate FB is transported by rotating the roller body of the so-called main driving roller by equipping with the driving device, but the invention is not limited thereto. For example, the roller may be rotated in accordance with the movement of the sheet substrate FB without being equipped with the driving device.

In the above description, a case has been exemplified in which a gas is used as a fluid supplied between the roller body and the substrate, but the invention is not limited thereto. For example, the invention may be applied when a liquid is used. The type of a gas or a liquid supplied between the roller body and the substrate may be changed in accordance with, for example, the atmosphere in which the process is performed in the processing apparatus. For example, in the case of the above-described embodiments, when the roller apparatuses R2 and R3 are used in a treatment process such as etching, that is, a wet environment, a development liquid used in etching may be used.

Further, in the above-described embodiments, a configuration has been exemplified in which the roller apparatus RN is disposed at a position between the processing apparatuses 10 performing a treatment on the sheet substrate FB, but the invention is not limited thereto. For example, the roller apparatus RN may be disposed at one of the upflow side and the downflow side of the transportation direction of the sheet substrate FB.

Furthermore, the roller apparatus RN may be disposed at a different position such as a position distant from the processing apparatus 10. For example, when plural types of treatment processes are performed on the sheet substrate FB, the treatment time for each process may be different. In this case, for example, a sheet bending portion that holds the sheet substrate FB in a bending state without applying a tension thereto is provided, and the roller apparatus RN of the above-described embodiment may be used to adjust the loosened state of the sheet substrate FB.

1. A roller apparatus that is used to transport a transportation target, the roller apparatus comprising:
a roller body which is adapted to be rotatable; and
a flow forming apparatus which forms a flow of a fluid between a surface of the roller body and the transportation target.

2. The roller apparatus according to claim 1, wherein the flow forming apparatus forms a flow of the fluid in the rotation direction of the roller body.

3. The roller apparatus according to claim 1, wherein the flow forming apparatus includes a fluid discharge portion which is provided on the surface of the roller body.

4. The roller apparatus according to claim 3,
wherein the roller body is formed as a cylindrical shape, and
wherein the fluid discharge portion includes at least one fluid discharge port formed on the roller body and a fluid supply mechanism connected to the fluid discharge port.

5. The roller apparatus according to claim 4, further comprising:
a partition member which divides an internal space of the roller body into a plurality of spaces,
wherein the fluid supply mechanism is connected to the fluid discharge port via the plurality of spaces.

6. The roller apparatus according to claim 4, wherein the fluid discharge port faces the rotation direction of the roller body.

7. The roller apparatus according to claim 4,
wherein a plurality of the fluid discharge ports is provided on the surface of the roller body, and
wherein the plurality of the fluid discharge ports is arranged in the rotation axis direction of the roller body.

8. The roller apparatus according to claim 3, wherein the flow forming apparatus includes a fluid suction portion which is provided on the surface of the roller body and sucks the fluid discharged from the fluid discharge portion.

9. The roller apparatus according to claim 8, wherein the fluid discharge portion and the fluid suction portion are alternately provided in the rotation direction of the roller body.

10. The roller apparatus according to claim 1, further comprising:
a driving device which rotates the roller body.

11. A transportation apparatus comprising:
a roller apparatus which is provided in at least a part of a transportation path of a transportation target,
wherein the roller apparatus according to claim 1 is used as the roller apparatus.

12. The transportation apparatus according to claim 11, further comprising:
a guide member which is provided in at least one of the upflow side and the downflow side of the roller apparatus in the transportation direction of the transportation target and guides the transportation target.

13. The transportation apparatus according to claim 12, further comprising:
a fluid supply portion which supplies a fluid to between the guide member and the transportation target.

14. The transportation apparatus according to claim 13, wherein the pressure of the fluid supplied from the fluid supply portion is larger than that in the flow of the fluid formed by the flow forming apparatus.

15. The transportation apparatus according to claim 11, further comprising:
a collection portion which is provided to face a surface different from a surface facing the transportation target in the surface of the roller body, and collects a part of the fluid flowing from the surface of the roller body.

16. The transportation apparatus according to claim 11, wherein the roller apparatus is provided in at least one of the upflow side and the downflow side of a treatment portion performing a predetermined treatment in the transportation direction of the transportation target.
